(19) United States
(12) Patent Application Publication
(10) Pub. No.: US 2025/0165707 A1
(43) Pub. Date: May 22, 2025

(54) ENHANCING PARAGRAPH JUSTIFICATION ACROSS MULTIPLE PARAGRAPHS

(71) Applicant: Adobe Inc., San Jose, CA (US)

(72) Inventors: Ashish Jain, Delhi (IN); Arushi Jain, Delhi (IN)

(21) Appl. No.: 18/515,759

(22) Filed: Nov. 21, 2023

(51) Int. Cl. G06F 40/189

(52) U.S. Cl. CPC G06F 40/189

(57) ABSTRACT

Techniques for enhancing paragraph justification across multiple paragraphs are provided. In an example method, a processing device determines a first and second spacing metrics for first and second justified paragraphs of text, respectively, in a digital document. The processing device determines an aggregate spacing metric for the first and second justified paragraphs based on the first spacing metric and the second spacing metric. Based on a difference between the first spacing metric and the aggregate spacing metric, the processing device modifies one or more spacing characteristics of the first justified paragraph based on a first penalty value, wherein the one or more spacing characteristics of the first justified paragraph comprise at least one of word spacing, letter spacing, or glyph scaling and causes the modified first justified paragraph to be displayed in a graphical user interface (GUI).

### TECHNICAL FIELD

This disclosure relates generally to electronic text processing. More specifically, but not by way of limitation, this disclosure relates to enhancing paragraph justification across multiple paragraphs.

### BACKGROUND

Justification of text in a typewritten digital document refers to the alignment of the start and end of a line of text with both the left and right margins, respectively, and then adjusting the spacing between words in the line to fill the width of the column. Justification can give the text a cleaner and more professional look. Text justification may thus be used in books, newspapers, magazines, and formal publications.

However, naive justification of text can result in uneven spacing between words or between characters within words. Justification may also result in overly many or haphazardly placed hyphenations throughout a paragraph. In some cases, differing levels of justification may be applied to different sections of the text. These effects may result in poor type color or noticeable differences or distortions that vary throughout the document, which may in turn affect readability of the document, especially for people with cognitive disabilities, such as dyslexia.

### SUMMARY

Certain embodiments involve enhancing paragraph justification across multiple paragraphs in a digital document. In one example method, a processing device configured to display a graphical user interface (GUI) is used for word processing or desktop publishing. While generating or editing a digital document, a request to enhance the justification of a selected number of justified paragraphs is received. The processing device first calculates spacing metrics, such as an average word spacing, for each of the selected justified paragraphs. The spacing metrics determined for each of the selected paragraphs are then aggregated. For example, the spacing metrics can be averaged to determine an average spacing metric for all of the selected justified paragraphs. The difference between the spacing metrics determined for each justified paragraph and the aggregate spacing metric are then used as a basis to modify the spacing characteristics of the selected justified paragraphs, such as the word spacing, letter spacing, or glyph scaling. For example, if the average word spacing in a paragraph is greater than the average word spacing for all paragraphs, then the word spacing, letter spacing, or glyph scaling in the paragraph are imperceptibly reduced. A penalty value, or another measure of the visual appeal of the paragraph, is used as part of an iterative process to judge the desirability of the changes until an optimized set of modifications are identified for the given justified paragraph. This process is repeated for each paragraph of the selected justified paragraphs. The determined modifications are then applied to each justified paragraph and the resulting enhanced justified paragraphs are updated on the GUI shown on the processing device.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a digital document processing system that for enhancing paragraph justification across multiple paragraphs, according to some aspects of the present disclosure.

FIG. 2 shows a detail view of example text formatted using techniques for enhancing paragraph justification across multiple paragraphs, according to some aspects of the present disclosure.

FIG. 3 depicts a user interface that may used for enhancing paragraph justification across multiple paragraphs in some implementations, according to some aspects of the present disclosure.

FIG. 4 shows a flowchart of an example method for enhancing paragraph justification across multiple paragraphs, according to some aspects of the present disclosure.

FIG. 5 shows a flowchart of an example method for determining a modification to the spacing characteristics of a justified paragraph that may be used for enhancing paragraph justification across multiple paragraphs, according to some aspects of the present disclosure.

FIG. 6 depicts an example of the computing system for implementing certain embodiments of the present disclosure.

### DETAILED DESCRIPTION

Full justification of text, as is often seen in published materials, involves alignment of text with both the left and right margins of a column or page, followed by adjustment of the spacing between the words on a line. Justification is performed, for example, on individual lines of text. A typical approach to line justification involves adjusting the spacing between the words in a line of text. However, such approaches often result in bad type color (e.g., the density or tone of a page of text when viewed from a distance) since there are only a limited number of spaces between words across which space can be distributed in a given line. Hyphenation is therefore sometimes used to change the length of the last word on a line of text to add to the available possibilities for adjusting spacing. Various approaches have been developed to improve spacing and hyphenation in justified text in a digital document to improve readability and accessibility of the document.

For example, one existing approach involves analyzing word spacing across an entire paragraph by considering various possible line breaks or by optimizing earlier lines in the paragraph to prevent undesirable line breaks later in the paragraph. However, this approach, when applied to individual paragraphs, may result in disparate results between paragraphs. To achieve uniform type color among several paragraphs, users must manually adjust typographic parameters, or spacing characteristics, such as word spacing, glyph scaling, and glyph spacing.

Manual adjustments to these settings may have undesirable side effects. For example, if the glyph scaling is changed for a portion of the text, it can create noticeable changes in the widths of vertical strokes of the glyph as compared with another unadjusted portion, which can hamper the printability and readability of the text. As a result, users have to rewrite content in a manner that results in high quality justification using a clumsy trial and error method. These manual adjustments result in a poor user experience due to the outsized manual effort required, frequent rework, and non-scalability of the approach to longer documents.

Uniform type color and visually appealing text justification across multiple paragraphs in a document can be achieved using techniques for enhancing paragraph justification across multiple paragraphs presented herein. The following non-limiting example method is provided to introduce certain embodiments. In the example method, a word processing program executing on a processing device receives a selection of two justified paragraphs of text in a digital document presented in a graphical user interface (GUI) for enhanced justification.

The processing device then determines a spacing metric for a justified paragraph of text and another spacing metric for another justified paragraph of text of the selected paragraphs. For instance, the processing device can determine a paragraph-level metric, such as the average word spacing, for the each of the two justified paragraphs as the spacing metric. The average word spacing can be determined by measuring the word spacing between every word in a paragraph and then determining the average word spacing for the entire paragraph.

The processing device then determines an aggregate spacing metric for the selected justified paragraphs based on the two spacing metrics just determined. For example, the average word spacings that were determined for the two selected justified paragraphs can be averaged together to obtain an overall average word spacing, sometimes referred to as the average common spacing value. The aggregate spacing metric thus characterizes the word spacing among both of the selected justified paragraphs.

To enhance the justification, a set of spacing characteristics (e.g., word spacing, letter spacing, or glyph scaling) of the two selected paragraphs are adjusted, such that the spacing metric of each individual paragraph becomes closer to the aggregate spacing metric, resulting in both paragraphs having a more uniform, justified appearance or type color. For example, if the average common spacing value is greater than the average word spacing of the first justified paragraph, word spacing that is closer to the average common spacing value can be attained through slight, imperceptible increases in the spacing characteristics. For instance, the word spacing, letter spacing, or glyph scaling may each be increased by a small amount, such as 1%. In some examples, the extent of modifications to the spacing characteristics may be limited to a predefined maximum value (e.g., 10%) to ensure that the changes do not cause noticeable or perceptible changes to the glyphs or spacing.

Following the modifications to the spacing characteristics, the results of the modifications are measured using a metric such as the penalty value. The penalty value is a numerical value used in line-breaking algorithms to indicate the desirability of a potential modification or breakpoint. A lower penalty suggests a more desirable modification or breakpoint, while a higher penalty suggests a less desirable one. The techniques disclosed herein are configured to minimize the penalty value for various possible adjustments, thus resulting in fewer hyphens and better breaks where hyphens do occur.

For example, the modifications can result in changes to the justified text such as changes in hyphenation location, orphaned lines, consecutively hyphenated words, and so on. These changes negatively or positively affect the penalty value. The penalty value before and after the modifications is compared to determine whether the changes improved the type color of the paragraph (e.g., by leading to a lower penalty value) while also changing the overall paragraph spacing to be closer the value of the aggregate spacing metric. In some examples, various approaches, including an algorithmic approach, may be used to select an optimized set of spacing characteristics. The optimized set of spacing characteristics may be one that minimizes the difference between each of the selected paragraphs' spacing metrics and the aggregate spacing metrics, while also minimizing the penalty value for each paragraph.

Once an optimized set of spacing characteristics is identified for each of the selected paragraphs, they are applied to the selected paragraphs. The enhanced paragraphs are then displayed on the GUI of the processing device. The modified paragraphs now have spacing that appears more similar to a paragraph having the aggregate spacing metric as well as noticeably improved type color. In some examples, these steps can be repeated for other justified paragraphs in the document, which can result in a more uniform type color across the document with no perceptible changes to the spacing characteristics.

In some examples, an algorithmic approach is used to select the optimized set of spacing characteristics. For instance, a range or other collection of possible spacing characteristics modifications may be determined based on the difference between the spacing metric determined for each paragraph and the aggregate spacing metric. An algorithm, such as a binary search, is then used to explore the parameter space of the range or collection to determine the optimized set of spacing characteristics.

In some examples, the spacing characteristics can be modified individually, rather than as a set. For example, if a set of spacing characteristics includes word spacing, letter spacing, or glyph scaling, a range of possible values for each spacing characteristic can be determined based on the difference between the spacing metric determined for each paragraph and the aggregate spacing metric. Then, the value of the spacing metric can be varied independently of the others, resulting in an optimized spacing characteristic modification value for each of the set of spacing characteristics.

The techniques of the present disclosure constitute significant improvements to the technical fields of electronic text processing and digital accessibility. Using existing systems and methods, the attainment of uniform spacing and type color across multiple paragraphs in a digital document was only possible with labor-intensive, manual interventions. The techniques herein can achieve visually pleasing and evenly spaced text justified paragraph layouts with minimal effort, while preserving other aspects of document aesthetics and consistency. Likewise, the techniques can enable greater adoption and usage of justification properties where they are known to be improved, easier to use, and lacking the long-felt deficiencies of existing systems and methods.

Moreover, because of the reduced need for manual text editing, the techniques disclosed herein reduce the load on processing resources and memory. Indeed, in some configurations, the techniques of the present disclosure can be applied asynchronously, for instance, as a final step in document preparation or editing. In that case, the CPU time and memory utilized by the methods disclosed herein may be consumed just-in-time while there is no other significant demand for processing resources. In some examples, the methods can be applied in parallel, performing the paragraph-level optimizations at the same time, thus further reducing CPU time needed for the enhancing of paragraph justification across multiple paragraphs. In these cases, shared memory resources can be used to minimize the memory footprint of the implementation as by, for instance, sharing the aggregate spacing metric value among the threads operating in parallel.

In addition, the accessibility of the text is significantly improved using the techniques disclosed herein. Particularly for individuals with disabilities such as dyslexia, beneficial to people with, more uniform justified text across paragraphs means that individuals with certain cognitive disabilities can read text more easily when the spacing between words is regular.

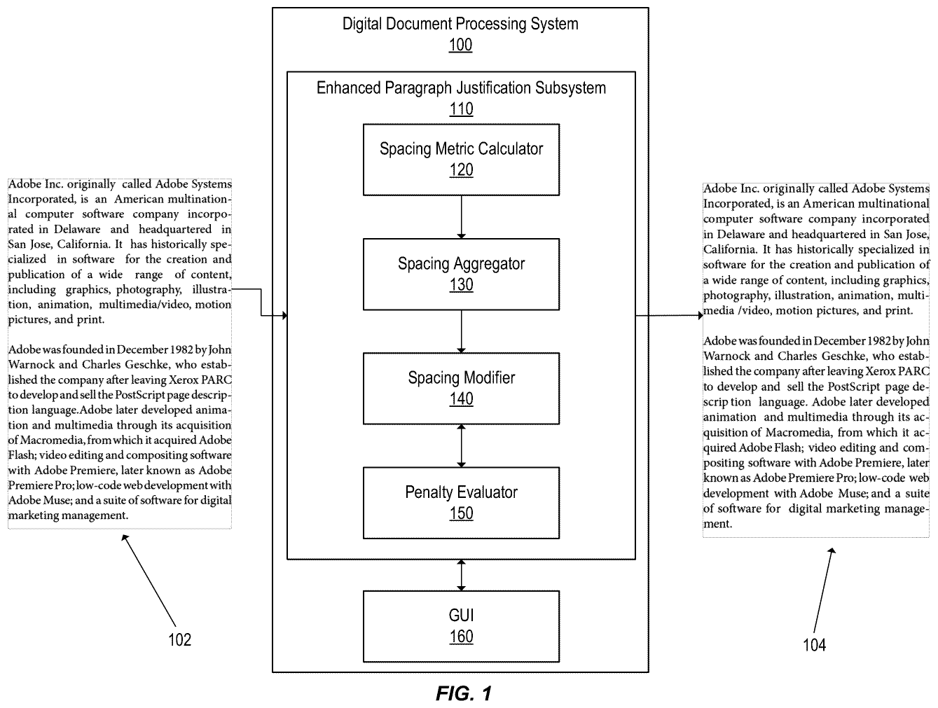

Referring now to the drawings, FIG. 1 depicts an example of a digital document processing system 100 that implements the enhancing of paragraph justification across multiple paragraphs. The digital document processing system 100 includes components for word processing, desktop publishing, editing, and so on. The example digital document processing system 100 also includes a graphical user interface (GUI) 160 for displaying the output. Some embodiments of the digital document processing system 100 may be included in computer or mobile devices such as desktops, laptops, smartphones, or tablets. These devices may include a display device such as a screen that can be used for displaying the GUI 160.

The example digital document processing system 100 includes an enhanced paragraph justification subsystem 110. The enhanced paragraph justification subsystem 110 includes components for, among other things, determining spacing metrics, adjusting spacing characteristics, and evaluating penalty value.

In one example implementation, the enhanced paragraph justification subsystem 110 receives the justified paragraphs 102. The digital document processing system 100 is used for creating, editing, or updating the document including the justified paragraphs 102. In this example, the first paragraph of the justified digital document 102 has a lighter type color than the second paragraph. In this context, “type color” refers to the perceived density or darkness of a block of text on a page, which is influenced by factors such as font choice, font weight, font size, letter size, letter spacing, word spacing, and so on. The type color discrepancy may be noticed by a user of the digital document processing system 100 or may be detected using an automated component provided by the digital document processing system 100. For instance, the digital document processing system 100 can receive, from a client device, an indication to enhance the justification of a selection of paragraphs of text in a digital document. The indication may be, for example, a selection made using an input device such as a mouse.

The enhanced paragraph justification subsystem 110 includes a spacing metric calculator 120. The spacing metric calculator 120 determines spacing metrics for justified paragraphs 102. For example, the spacing metric calculator 120 may calculate a word spacing metric for each of the justified paragraphs 102. In one implementation, the spacing metric calculator 120 measures the word spacing between each pair of words from a paragraph of the justified paragraphs 102 and calculates the average word spacing for that paragraph. In this example, the spacing metric is the average word spacing for the paragraph. For the justified paragraphs 102, this process is repeated for each paragraph, thus associating a spacing metric with each justified paragraph.

The enhanced paragraph justification subsystem 110 further includes a spacing aggregator 130. The spacing aggregator 130 receives calculated spacing metrics from the spacing metric calculator 120 and determines an aggregate spacing metric for the justified paragraphs 102. For example, the spacing aggregator 130 may calculate the average word spacing value for the word spacing metrics calculated for each justified paragraph by the spacing metric calculator 120. This is referred to as the “average common spacing value” in certain examples. The aggregate spacing metric may be stored, cached, or otherwise persisted for use in enhancing paragraph justification across multiple paragraphs.

The enhanced paragraph justification subsystem 110 includes a spacing modifier 140. The spacing modifier 140 firsts determine a difference between the spacing metric and the aggregate spacing metric. For example, an average word spacing can be calculated for each justified paragraph of the justified paragraphs 102. Likewise, an average common spacing value can be calculated that is representative of all of the justified paragraphs 102 that are input to the enhanced paragraph justification subsystem 110. The spacing modifier 140 can then calculate a difference between these two values. Word spacing is measured in points and there are 72 points in one inch. In an example, if the average word spacing is 4 points in a first justified paragraph and 6 points in a second justified paragraph, the average common spacing value is 5 points. The resulting differences are −1 point and 1 point, respectively. In this example, the difference is simply defined as subtraction, but other difference measures are compatible. For instance, the difference can be measured using ratios (i.e., division), weighted combinations, non-quantitative comparisons, and so on.

Based on the relative difference between each paragraph's spacing metric and the aggregate spacing metric, the spacing modifier 140 modifies certain spacing characteristics of the justified paragraphs based on a determined penalty value. For example, the spacing modifier 140 may modify spacing characteristics such as word spacing, letter spacing, or glyph scaling, among other characteristics, to close the gap between the paragraph-level spacing metric and the aggregate spacing metric. The modifications are selected so that they are imperceptible to human readers. By making slight, imperceptible spacing characteristics modifications to each justified paragraph the digital document, or a selected subset of justified paragraphs therein, a more uniform type color, improved visual appeal, or better accessibility is attained.

In a typical implementation, one or more spacing characteristics are modified together and the effect of the modifications are evaluated according to the penalty value. The penalty value is a quantification of the undesirability or deviation of a particularly formatted paragraph from an ideal. A lower penalty value typically corresponds to proximity to a desired typographic standard, while a higher penalty generally indicates a greater deviation from the ideal. For example, adjusting word breaks in one paragraph may result in a noticeably different type color as compared with another similarly adjusted paragraph. The enhanced paragraph justification subsystem 110 further includes a penalty evaluator 150 that is used to determine the penalty value before and after modifications to the spacing characteristics.

The spacing modifier 140 and the penalty evaluator 150 are used iteratively to optimize the spacing characteristics for a particular justified paragraph. For instance, the spacing modifier 140 may use a computer-implemented procedure to select a set of spacing characteristics modifications, apply them, and then send then to penalty evaluator 150 for evaluation. The spacing modifier 140 and the penalty evaluator 150 can operate thusly in a loop until an optimized set of spacing characteristics are obtained or a default set of spacing characteristics is used in the event an optimized set cannot be identified. Likewise, the spacing modifier 140 and the penalty evaluator 150 are iteratively operated to apply the same optimization approach to each paragraph of the numerous selected justified paragraphs.

Following optimization of the spacing characteristics for each justified paragraph of the justified paragraphs 102 and application of the optimized modifications to each paragraph, the enhanced paragraph justification subsystem 110 causes the modified first justified paragraph to be displayed in a GUI 160. For example, the GUI 160 may display the enhanced justified paragraphs 104. The type color and uniformity of enhanced justified paragraphs 104 is apparent alongside justified paragraphs 102.

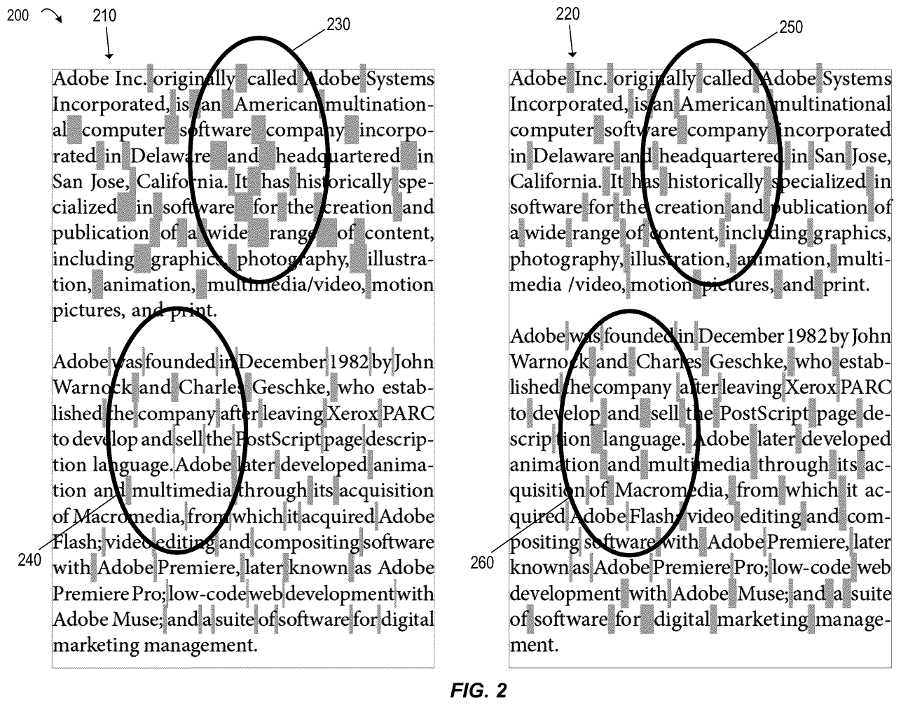

FIG. 2 shows a detail view of example text 200 formatted using techniques for enhancing paragraph justification across multiple paragraphs, according to some aspects of the present disclosure. Justified paragraphs 210 are shown with shaded boxes corresponding to word spacing before the application of the techniques disclosed herein. Enhanced justified paragraphs 220 are shown with shaded boxes corresponding to word spacing after the application of the techniques disclosed herein.

In one example, the word spacing for each paragraph and then the average common spacing value of all of the justified paragraphs 210 selected or indicated for enhancement are calculated. The difference between these two values, for each justified paragraph, are used to modify certain spacing characteristics such as word spacing, letter spacing, or glyph scaling such that the word spacing is closer to the average common spacing value. Other spacing characteristics, such as kerning, font weight, font style, font variant, font size, baseline shifts, indentation, hyphenation, or text orientation may also be modified in some implementations.

In this example, the spacing characteristics modifications are configured to be imperceptible. Enhanced justified paragraphs 220 have been enhanced through modifications to word spacing, letter spacing, or glyph scaling, although it may not be readily apparent from a visual comparison with unenhanced justified paragraphs 210. Through these modifications, unenhanced justified paragraphs 210 include several large word spacings 230 and several small word spacings 240, that are not evident in comparable regions 250, 260 of the enhanced justified paragraphs 220. Instead, more uniform spacing and better type color is evident in these regions 250, 260.

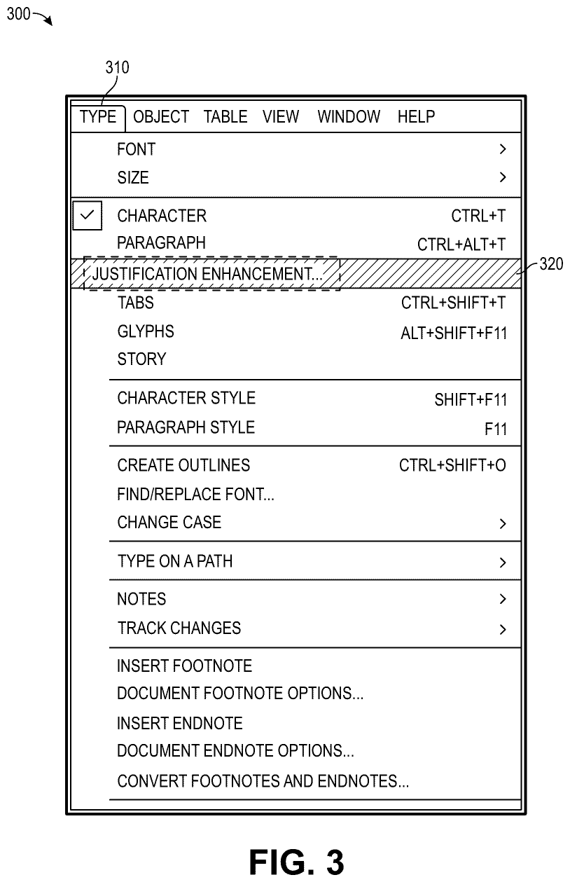

FIG. 3 depicts a user interface (UI) 300 used in some implementations of systems for enhancing paragraph justification across multiple paragraphs, according to some aspects of the present disclosure. In some examples, a processing device receives, from a client device, an indication to enhance a justification of a selection of a plurality of justified paragraphs of text in a digital document. The indication may be generated using a UI 300. For instance, one or more justified paragraphs may be selected using a suitable input device. Once the justified paragraphs are selected, the user may click on user interface control such as menu 310. This depiction shows the “Type” menu, but the justification enhancement control 320 may be configured in any suitable UI location. In this example, the justification enhancement control 320 is a menu item but any other suitable UI control such as a checkbox, radio selector, etc. may be used.

In some examples, selection of justification enhancement control 320 causes a configuration window or modal that can be used to specify additional configurations relating to enhancing paragraph justification across multiple paragraphs. For example, limits with respect to the degree of spacing characteristics modifications that can be applied, search algorithms used to determine the optimized spacing characteristics, specification of how to calculate the penalty value, and other options may be included among possible configuration options. Configuration options may be applied using other suitable methods such as operating system-level configurations, text-based configuration files, and so on.

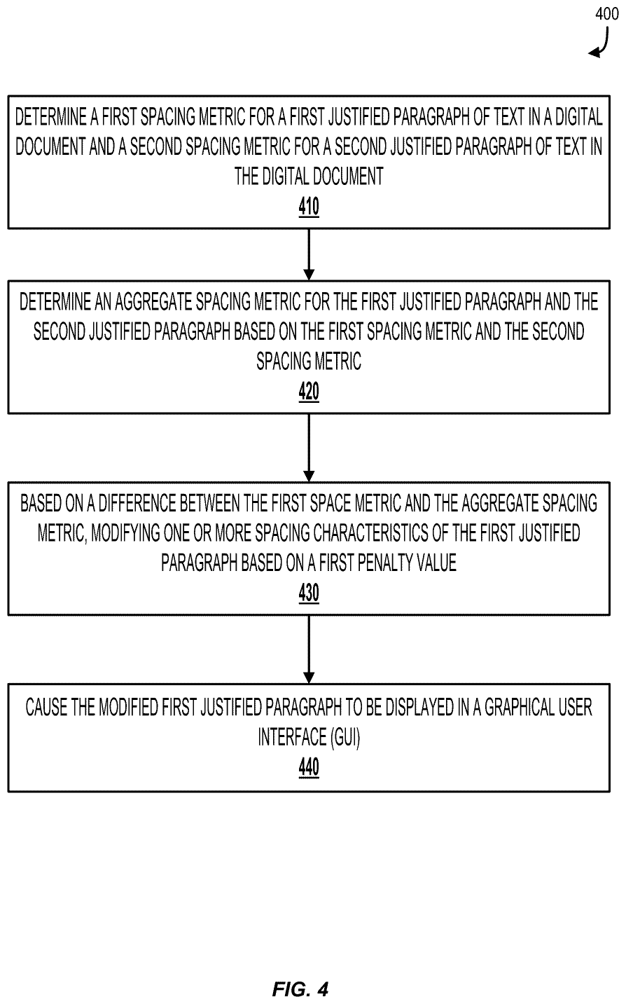

FIG. 4 shows a flowchart of an example method 400 for enhancing paragraph justification across multiple paragraphs. The description of the method 400 in FIG. 4 will be made with reference to FIG. 1, however any suitable system according to this disclosure may be used. It should be appreciated that method 400 provides a particular method for enhancing paragraph justification across multiple paragraphs. Other sequences of operations may also be performed according to alternative examples. For example, alternative examples of the present disclosure may perform the steps outlined above in a different order. Moreover, the individual operations illustrated by method 400 may include multiple sub-operations that may be performed in various sequences as appropriate to the individual operation. Furthermore, additional operations may be added or removed depending on the particular applications. Further, the operations described in method 400 may be performed by different devices. For example, the description is given from the perspective of a processing device such as the digital document processing system 100 but other configurations are possible. One of ordinary skill in the art would recognize many variations, modifications, and alternatives.

At block 410, a processing device determines a first spacing metric for a first justified paragraph of text in a digital document and a second spacing metric for a second justified paragraph of text in the digital document. For example, the processing device may include a component such as the spacing metric calculator 120 that can calculate a word spacing metric such as the average word spacing for each of the justified paragraphs 102. For the justified paragraphs 102, this process is repeated for each paragraph, thus associating a spacing metric with each justified paragraph.

In some examples, the average word spacing is determined for a justified paragraph including at least three words. First, a spacing measurement between a first word and the second word is found, and then a spacing measurement between the second word and a third word is found. The spacing measurements may be made using an application programming interface (API) exposed by the underlying digital document processing system 100. For example, some word processing applications may include an API for measuring word spacing directly or for measuring word spacing indirectly using an API for the width of a space character or string of spaces. Given these at least two word spacing measurements, the processing device determines an average spacing measurement based. For example, the average of the at least two word spacing measurements can be used and designated as the spacing metric that characterizes the justified paragraph.

At block 420, the processing device determines an aggregate spacing metric for the first justified paragraph and the second justified paragraph based on the first spacing metric and the second spacing metric. For instance, the aggregate spacing metric for the first justified paragraph and the second justified paragraph may be obtained by averaging the first spacing metric and the second spacing metric. In some examples, the average spacing metric may be referred to as the average common spacing value. Other aggregate measures can be used to characterize the justified paragraphs such as mode, median, minimum, maximum, standard deviation, variance, among many others. Using different aggregate measures may result in subtle variations in uniformity or type color of the enhanced justified paragraphs.

The processing device determines an initial penalty value for the justified paragraph and then at block 430, based on a difference between the first spacing metric and the aggregate spacing metric, modifies one or more spacing characteristics of the first justified paragraph based on a first penalty value. For example, the modifications may be drawn from a range or subset of possible values based on a comparison of the paragraph-level spacing metric and the aggregate spacing metric. For instance, if the average word spacing of a justified paragraph is larger than the average common spacing value, then a range of −10% to 0% may be established. The negative range corresponds to adjustments to spacing characteristics that tend to reduce the average word spacing so that it is closer to the average word spacing. For example, modifications that reduce word spacing, reduce letter spacing, or reduce glyph scaling may also reduce the average word spacing for a given justified paragraph. Likewise, if the average word spacing of a justified paragraph is smaller than the average common spacing value, then a range of 0% to 10% may be established. The absolute magnitude of the range may correspond to a predefined percentage value that relates to empirically derived imperceptible changes. For instance, the predefined percentage value may be 10%, but other implementations may use different values, non-integer values, ranges that include both positive and negative values, among other possible variations. Typical implementations have a predefined percentage value in the range bounded by about 5% to about 15%.

The range may include a number of values for spacing characteristics modifications. For example, a range of 0% to 10% may include 10 integer values, but sub-integer values may be used for additional precision. For each value in the range, one or more spacing characteristics modifications can be determined based on the value. For instance, a value in the middle of the range may be selected, e.g., 5%. Then one or more spacing characteristics may be modified by 5%. Consider an example in which the justified paragraph has a word spacing of 2 ems, a letter spacing of 10 points, and glyph scaling of 100%. If a 5% modification is applied to these spacing characteristics, the resultant justified paragraph may have word spacing 2.1 ems, a letter spacing of 10.5 points, and glyph scaling of 105%.

In various examples, selection of the value from the range may be performed iteratively according to a predetermined ordering, randomly, or algorithmically. For instance, selection of the value may be based on a binary search of the subset of the possible spacing characteristics modification values.

In a binary search applied to the modification of spacing characteristics, an optimized value can be determined by beginning with a middle element of the sorted range, making the corresponding spacing characteristics modifications, and then calculating a new penalty value. The penalty value can be compared with the initial penalty value to determine which direction to proceed in the range. In some examples, the optimized modified penalty value corresponds to a minimum penalty value relative to the initial value or newly tested values. If the new penalty value is less than the initial penalty value, the modification improved the condition of the justified paragraph. If the new penalty value is greater than the initial penalty value, the modification worsened the condition of the justified paragraph.

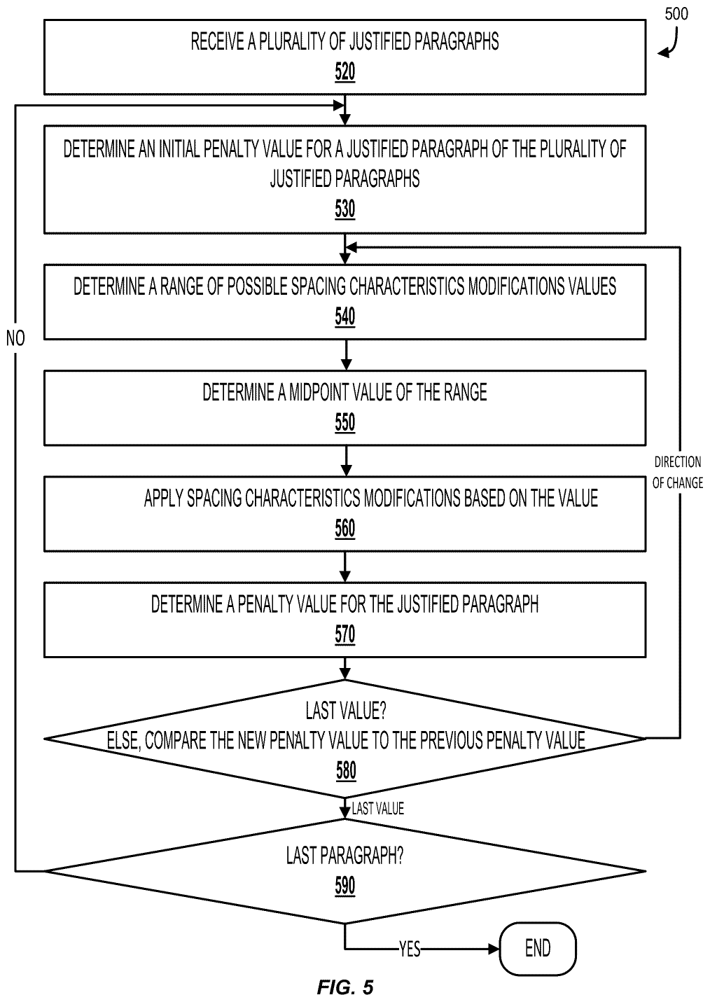

In the next round of the binary search, another value taken from the half of the sorted range corresponding to improved condition of the justified paragraph is selected and the process described in the previous paragraph can be repeated until an optimized value is found. For instance, for the sorted range including values {1%, 2%, 3%} and an initial penalty value of 50, the binary search algorithm may first apply the 2% spacing characteristics modifications and then calculate a new penalty value of 60, a reduction in the quality of the justification. Since a 2% increase in spacing characteristics resulted in an increased penalty value, the 1% value may be tested. In an example, this may correspond to a new penalty value of 45, or an improvement in the quality of the justification. In this example, then, 1% may be designated as the optimized modified penalty value. An example process including a binary search is shown in FIG. 5 and described in the accompanying description.

The optimized spacing characteristics modifications are applied to the justified paragraph and at block 440, the processing device causes the modified first justified paragraph to be displayed in a graphical user interface (GUI). For example, the client device executing the digital document processing system 100 may be configured to display a GUI 160 that can present the selected justified paragraphs with the optimized spacing characteristics applied.

FIG. 5 shows a flowchart of an example method 500 for determining a modification to the spacing characteristics of a justified paragraph that may be used for enhancing paragraph justification across multiple paragraphs The description of the method 500 in FIG. 5 will be made with reference to FIG. 1, however any suitable system according to this disclosure may be used. It should be appreciated that method 500 provides a particular method for enhancing paragraph justification across multiple paragraphs. Other sequences of operations may also be performed according to alternative examples. For example, alternative examples of the present disclosure may perform the steps outlined above in a different order. Moreover, the individual operations illustrated by method 500 may include multiple sub-operations that may be performed in various sequences as appropriate to the individual operation. Furthermore, additional operations may be added or removed depending on the particular applications. Further, the operations described in method 500 may be performed by different devices. For example, the description is given from the perspective of a processing device such as the digital document processing system 100 but other configurations are possible. One of ordinary skill in the art would recognize many variations, modifications, and alternatives.

Method 500 depicts a possible implementation for a binary search algorithm that may be used in some examples for determining optimized spacing characteristics, as briefly described above in block 430 of FIG. 4. At block 520, a processing device receives a plurality of justified paragraphs. For example, a user of a client device including a digital document processing system 100 may select several paragraphs with an input device (e.g., a mouse) using a click-and-drag method or a multi-select method. The user may apply the justified formatting option to the paragraph(s) and then make a selection for enhanced justification as shown in FIG. 3.

At block 530, the processing device determines an initial penalty value for a justified paragraph of the plurality of justified paragraphs. The initial penalty value is used a baseline for comparison for spacing characteristics modifications. In some examples, if an improved penalty value is not identified using the algorithm described herein, the enhanced paragraph justification subsystem 110 may be configured to use the initial spacing characteristics settings as the default values. However, other default values may be selected as well. For instance, some implementations may designate a single step that tends to make the paragraph spacing metric closer to the aggregate spacing metric the default (e.g., 5 for the range 0 to 10), even if it does not positively impact the penalty value. The initial penalty value may be cached for comparison with penalty values calculated during the iterative process of method 500.

At block 540, the processing device determines a range of possible spacing characteristics modifications values. For example, a range or subset of possible values may be determined for spacing characteristics modifications based on the aggregate spacing metric. For instance, if the average word spacing of a justified paragraph is larger than the average common spacing value, then a range of −10% to 0% may be established. In another example, a range of −18.5% to +1.5% may be used. The absolute magnitude of the range corresponds to a predefined percentage value that relates to empirically derived imperceptible changes. For instance, the predefined percentage value may be 10%, but other implementations may use different values, non-integer values, ranges that include both positive and negative values, among other possible variations. Moreover, in some examples, ranges may include sub-integer values may be used for additional precision.

At block 550, the processing device determines a midpoint value of the range. A new range is thus determined on the basis of the previous range in the binary search algorithm. In the binary search algorithm, the size of the range is approximately halved as the search narrows in on an optimized value. Thus, for example, the initial range may be from 0% to 10%, including 10 elements (excluding 0%, corresponding to the default case). The midpoint can be chosen as the middle value for an odd number of elements as one of the two middle values (e.g., randomly) for an even number of elements. In the example of 0% to 10%, the midpoint may be 5% or 6%, according to a particular selection procedure. If 5% is selected, two new ranges can be identified that may be used for the next iteration: 0% to 4% and 6% to 10%.

At block 560, the processing device applies spacing characteristics modifications based on the selected value. In the example above, if 5% is selected as the midpoint value of the initial range, a 5% modification is applied to one or more spacing characteristics. For instance, if the justified paragraph has a word spacing of 2 ems, a letter spacing of 10 points, and glyph scaling of 100%, a 5% modification can result in a word spacing 2.1 ems, a letter spacing of 10.5 points, and glyph scaling of 105%. In some examples, spacing characteristics modifications may be applied to each spacing characteristic independently. In that case, each spacing characteristic may be associated with a particular, dedicated range.

At block 570, the processing device determines a penalty value for the justified paragraph with the spacing characteristics modifications applied. The penalty value may be calculated using a suitable algorithm and may include factors including line stretch/shrink, word spacing variation, number of hyphenations, widowed and orphaned text, glyph overlap, line breaking choice, variation from ideal line length, letter spacing adjustments, large gaps in justified text, and so on. As with the initial penalty value, the newly calculated penalty value may be cached for comparison using ephemeral local storage such as RAM or a key-value store.

At block 580, the processing device compares the new penalty value to the previous penalty value. The relative values of the compared penalty values determine the next step taken in the iterative process 500. If the new penalty value is less than the previous penalty value (or the initial penalty value), this may indicate that the set of spacing characteristics modifications has improved the aesthetic appeal of the paragraph after justification, which is a quality the penalty value exists to capture. In contrast, if the new penalty value is greater than the previous penalty value (or the initial penalty value), this may indicate that the set of spacing characteristics modifications has worsened the visual appeal.

On the basis of this comparison, the next range is selected at 540. As mentioned, whether the visual appeal is improved or worsened as measured by the penalty value determines whether a higher or lower range will be used. If the penalty value was decreased by the modifications (improved), the next range may have a magnitude beyond (greater than) the previously tested value. Generally, for a positive range, this corresponds to a positive step and for a negative range it corresponds to a negative step. For a mixed range, the range should be chosen such that the trend indicated by the new penalty value is further tested.

Following selection of a new range, the algorithm loop between blocks 540 and 570 repeats until only a single value remains, or the results are indeterminate. If a single value is reached in a range through this iterative process, that value is designated as the optimized value. In some cases, the binary search algorithm may not converge on an optimized value. For instance, the penalty value may not consistently improve since application of the spacing characteristics modifications is not guaranteed to produce consistent results among justified paragraphs of differing text, content, fonts, styles, etc. In this case, an unmodified, prespecified value, or other approach to selection of a default value may be used.

Following determination of an optimized value or designation of a default value, at block 590, the processing device determines whether the last justified paragraph among the plurality of selected or indicated justified paragraphs has been processed. If there are additional justified paragraphs for processing, the process 500 beginning with block 530 repeats. The binary search algorithm proceeds through each paragraph as described above until each justified paragraph of the plurality of paragraphs has an associated optimized value or default value selected and applied. If the last justified paragraph among the plurality of selected or indicated justified paragraphs has been processed, then the process 500 ends. In some examples, the optimized spacing characteristics that have been identified can be applied to the selected paragraphs and the modified paragraphs can be displayed on a suitable GUI, as described above with respect to block 440.

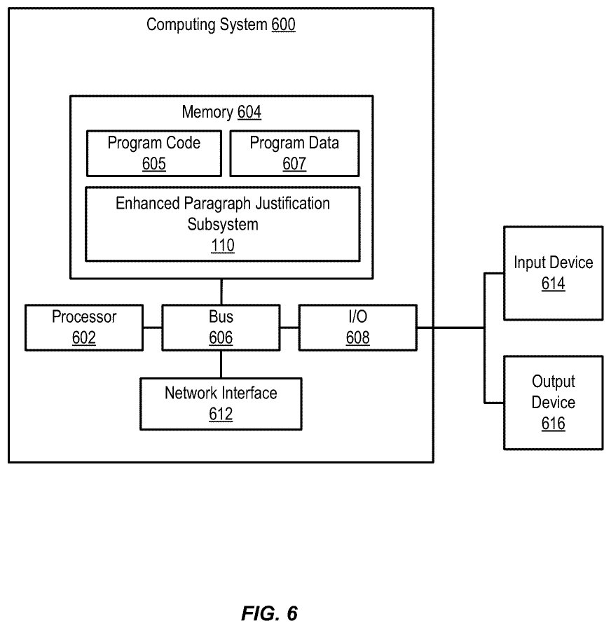

Any suitable computing system or group of computing systems can be used for performing the operations described herein. For example, FIG. 6 depicts an example of the computing system 600 for implementing certain embodiments of the present disclosure. The implementation of computing system 600 could be used to implement the enhanced paragraph justification subsystem 110. In other embodiments, a single computing system 600 having devices similar to those depicted in FIG. 6 (e.g., a processor, a memory, etc.) combines the one or more operations depicted as separate systems in FIG. 1.

The depicted example of a computing system 600 includes a processor 602 communicatively coupled to one or more memory devices 604. The processor 602 executes computer-executable program code stored in a memory device 604, accesses information stored in the memory device 604, or both. Examples of the processor 602 include a microprocessor, an application-specific integrated circuit (“ASIC”), a field-programmable gate array (“FPGA”), or any other suitable processing device. The processor 602 can include any number of processing devices, including a single processing device.

A memory device 604 includes any suitable non-transitory computer-readable medium for storing program code 605, program data 607, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 600 executes program code 605 that configures the processor 602 to perform one or more of the operations described herein. Examples of the program code 605 include, in various embodiments, the application executed by the enhanced paragraph justification subsystem 110, or other suitable applications that perform one or more operations described herein. The program code may be resident in the memory device 604 or any suitable computer-readable medium and may be executed by the processor 602 or any other suitable processor.

In some embodiments, one or more memory devices 604 stores program data 607 that includes one or more datasets and models described herein. In some embodiments, one or more of data sets, models, and functions are stored in the same memory device (e.g., one of the memory devices 604). In additional or alternative embodiments, one or more of the programs, data sets, models, and functions described herein are stored in different memory devices 604 accessible via a data network. One or more buses 606 are also included in the computing system 600. The buses 606 communicatively couples one or more components of a respective one of the computing system 600.

In some embodiments, the computing system 600 also includes a network interface device 612. The network interface device 612 includes any device or group of devices suitable for establishing a wired or wireless data connection to one or more data networks. Non-limiting examples of the network interface device 612 include an Ethernet network adapter, a modem, and/or the like. The computing system 600 is able to communicate with one or more other computing devices (e.g., a digital document processing system 100) via a data network using the network interface device 612.

The computing system 600 may also include the number of external or internal devices, an input device 620, a presentation device 618, or other input or output devices. For example, the computing system 600 is shown with one or more input/output (“I/O”) interfaces 608. An I/O interface 608 can receive input from input devices or provide output to output devices. An input device 614 can include any device or group of devices suitable for receiving visual, auditory, or other suitable input that controls or affects the operations of the processor 602. Non-limiting examples of the input device 614 include a touchscreen, a mouse, a keyboard, a microphone, a separate mobile computing device, etc. An output device 616 can include any device or group of devices suitable for providing visual, auditory, or other suitable sensory output. Non-limiting examples of the output device 616 include a touchscreen, a monitor, a speaker, a separate mobile computing device, etc.

Although FIG. 6 depicts the input device 614 and the output device 616 as being local to the computing device that executes the enhanced paragraph justification subsystem 110, other implementations are possible. For instance, in some embodiments, one or more of the input device 614 and the output device 616 can include a remote client-computing device that communicates with the computing system 600 via the network interface device 612 using one or more data networks described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

That which is claimed is:

1. A method performed by one or more processing devices, comprising:
determining a first spacing metric for a first justified paragraph of text in a digital document and a second spacing metric for a second justified paragraph of text in the digital document;
determining an aggregate spacing metric for the first justified paragraph and the second justified paragraph based on the first spacing metric and the second spacing metric;
based on a difference between the first spacing metric and the aggregate spacing metric, modifying one or more spacing characteristics of the first justified paragraph based on a first penalty value, wherein the one or more spacing characteristics of the first justified paragraph comprise at least one of word spacing, letter spacing, or glyph scaling; and
causing the modified first justified paragraph to be displayed in a graphical user interface (GUI).

2. The method of claim 1, wherein:
the first justified paragraph comprises a justified line comprising at least three words, including a first word, a second word, and a third word, wherein:
the first word and the second word are adjacent; and
the second word and the third word are adjacent; and
determining the first spacing metric for the first justified paragraph comprises:
determining a first spacing measurement between the first word and the second word;
determining a second spacing measurement between the second word and the third word;
determining an average spacing measurement based on the first spacing measurement and the second spacing measurement; and
designating the average spacing measurement as the first spacing metric.

3. The method of claim 1, wherein determining the aggregate spacing metric for the first justified paragraph and the second justified paragraph based on the first spacing metric and the second spacing metric comprises averaging the first spacing metric and the second spacing metric.

4. The method of claim 1, further comprising:
responsive to a difference between the second spacing metric and the aggregate spacing metric, modifying one or more spacing characteristics of the second justified paragraph based on a second penalty value, wherein the one or more spacing characteristics of the second justified paragraph comprise at least one of word spacing, letter spacing, or glyph scaling; and
causing the modified second paragraph to be displayed in the GUI.

5. The method of claim 1, wherein modifying the one or more spacing characteristics of the first justified paragraph based on the first penalty value comprises:
determining an initial penalty value for the first justified paragraph;
establishing a set of spacing characteristics modifications;
for each spacing characteristics modification in a subset of the set of spacing characteristics modifications:
selecting a spacing characteristics modification;
modifying the first justified paragraph using the spacing characteristics modification;
determining a modified penalty value for the first justified paragraph; and
comparing the initial penalty value with the modified penalty value;
based on the comparing the initial penalty value with the modified penalty values, identifying the spacing characteristics modification of the subset of the set of spacing characteristics modifications associated with an optimized modified penalty value, wherein the optimized modified penalty value is the first penalty value; and
modifying the first justified paragraph using the spacing characteristics modification of the subset of the set of spacing characteristics modifications associated with the optimized modified penalty value.

6. The method of claim 5, wherein selecting the spacing characteristics modification is based on a binary search of the subset of the set of spacing characteristics modifications.

7. The method of claim 5, wherein the optimized modified penalty value corresponds to a minimum penalty value for the first justified paragraph.

8. The method of claim 5, wherein establishing the set of spacing characteristics modifications comprises:
determining a range for spacing characteristics modifications based on the aggregate spacing metric;
determining a plurality of values in the range for spacing characteristics modifications; and
for each value in the plurality of values in the range for spacing characteristics modifications, determine a spacing characteristics modification based on the value.

9. The method of claim 1, wherein the one or more spacing characteristics are modified by less than a predefined percentage value.

10. The method of claim 9, wherein:
a first spacing characteristic of the one or more spacing characteristics is modified by a first percentage value;
a second spacing characteristic of the one or more spacing characteristics is modified by a second percentage value; and
the first percentage value is different from the second percentage value.

11. The method of claim 9, wherein the predefined percentage value is in a range bounded by about 5% to about 15%.

12. A non-transitory computer-readable medium storing instructions that, when executed by one or more processors, cause the one or more processors to perform operations including:
receiving, for a plurality of justified paragraphs of text in a digital document, an aggregate spacing metric and a spacing metric for each justified paragraph; and
for each justified paragraph of the plurality of justified paragraphs, modifying at least one spacing characteristic comprising:
a step for determining a set of spacing characteristics modifications based on a difference between the spacing metric for the justified paragraph and the aggregate spacing metric;
a step for determining an optimized penalty value associated with a subset of the set of spacing characteristics modifications; and
modifying the justified paragraph using the subset of the set of spacing characteristics modifications associated with the optimized penalty value.

13. The non-transitory computer-readable medium claim 12, wherein:
a first justified paragraph comprises a justified line comprising at least three words, including a first word, a second word, and a third word, wherein:
the first word and the second word are adjacent; and
the second word and the third word are adjacent; and
determining the spacing metric for the first justified paragraph comprises:
determining a first spacing measurement between the first word and the second word;
determining a second spacing measurement between the second word and the third word;
determining an average spacing measurement based on the first spacing measurement and the second spacing measurement; and
designating the average spacing measurement as the spacing metric; and
determining the aggregate spacing metric for the plurality of justified paragraphs comprises averaging the spacing metric for each justified paragraph of the plurality of justified paragraphs.

14. The non-transitory computer-readable medium claim 12, wherein modifying the justified paragraph using the subset of the set of spacing characteristics modifications associated with the optimized penalty value comprises:
determining an initial penalty value for the justified paragraph;
establishing the set of spacing characteristics modifications;
for each spacing characteristics modification in the subset of the set of spacing characteristics modifications:
selecting a spacing characteristics modification;
modifying the justified paragraph using the spacing characteristics modification;
determining a modified penalty value for the justified paragraph; and
comparing the initial penalty value with the modified penalty value;
based on the comparing the initial penalty value with the modified penalty values, identifying the spacing characteristics modification of the subset of the set of spacing characteristics modifications associated with an optimized modified penalty value; and
modifying the justified paragraph using the spacing characteristics modification of the subset of the set of spacing characteristics modifications associated with the optimized modified penalty value.

15. The non-transitory computer-readable medium claim 12, wherein the set of spacing characteristics are modified by less than a predefined percentage value.

16. A system comprising:
one or more processors; and
one or more computer-readable storage media storing instructions which, when executed by the one or more processors, cause the one or more processors to perform operations including:
receiving, from a client device, an indication to enhance a justification of a selection of a plurality of justified paragraphs of text in a digital document;
determining spacing metrics for each justified paragraph of the plurality of justified paragraphs;
determining an aggregate spacing metric for the plurality of justified paragraphs based on the determined plurality of spacing metrics;
for each justified paragraph of the plurality of justified paragraphs, modifying one or more spacing characteristics based on a penalty value; and
outputting, to the client device, the modified justified paragraphs.

17. The system of claim 16, wherein:
determining spacing metrics for each justified paragraph of the plurality of justified paragraphs comprises, for each justified paragraph:
for each line of the justified paragraph, identifying a justified line comprising at least three words, including a first word, a second word, and a third word, wherein:
the first word and the second word are adjacent; and
the second word and the third word are adjacent; and
determining a first spacing measurement between the first word and the second word;
determining a second spacing measurement between the second word and the third word;
determining an average spacing measurement based on the first spacing measurement and the second spacing measurement; and
designating the average spacing measurement as the spacing metric for the justified paragraph; and
determining the aggregate spacing metric for each justified paragraph of the plurality of justified paragraphs based on the spacing metrics comprises averaging the spacing metrics.

18. The system of claim 16, wherein modifying the one or more spacing characteristics based on the penalty value comprises:
determining an initial penalty value for a first justified paragraph;
establishing a set of spacing characteristics modifications;
for each spacing characteristics modification in a subset of the set of spacing characteristics modifications:
selecting a spacing characteristics modification;
modifying the first justified paragraph using the spacing characteristics modification;
determining a modified penalty value for the first justified paragraph; and
comparing the initial penalty value with the modified penalty value;
based on the comparing the initial penalty value with the modified penalty values, identifying the spacing characteristics modification of the subset of the set of spacing characteristics modifications associated with an optimized modified penalty value, wherein the optimized modified penalty value is the penalty value; and
modifying the first justified paragraph using the spacing characteristics modification of the subset of the set of spacing characteristics modifications associated with the optimized modified penalty value.

19. The system of claim 18, wherein selecting the spacing characteristics modification is based on a binary search of the subset of the set of spacing characteristics modifications.

20. The system of claim 16, wherein the one or more spacing characteristics are modified by less than a predefined percentage value.
